(19) United States
(12) Patent Application Publication
(10) Pub. No.: US 2022/0156701 A1
(43) Pub. Date: May 19, 2022

(54) INFORMATION PROCESSING APPARATUS, INFORMATION PROCESSING METHOD, AND NON-TRANSITORY COMPUTER-READABLE STORAGE MEDIIUM

(71) Applicant: TOYOTA JIDOSHA KABUSHIKI KAISHA, Toyota-shi (JP)

(72) Inventors: Osamu Izumida, Nagoya-shi (JP); Mitsuhiro Miura, Okazaki -shi (JP); Xin Jin, Nagoya-shi (JP); Genshi Kuno, Kasugai-shi (JP)

(73) Assignee: TOYOTA JIDOSHA KABUSHIKI KAISHA, Toyota-shi (JP)

(21) Appl. No.: 17/466,125

(22) Filed: Sep. 3, 2021

(30) Foreign Application Priority Data
Nov. 13, 2020 (JP) 2020-189637

(51) Int. Cl. G06Q 10/10; G06K 9/00; G08B 5/22; G06Q 10/08

(52) U.S. Cl. CPC G06Q 10/1095; G06Q 10/083; G08B 5/22; G06K 9/00335

(57) ABSTRACT

A control unit of an information processing apparatus is configured to acquire schedule information including information on schedule time that is time at which a visitor is scheduled to visit a user in a predetermined place. The control unit is configured to, when a sign that the user leaves the predetermined place before the schedule time is detected based on an action of the user in the predetermined place, provide a notification to the user or the visitor.

### CROSS-REFERENCE TO RELATED APPLICATION

This application claims priority to Japanese Patent Application No. 2020-189637 filed on Nov. 13, 2020, incorporated herein by reference in its entirety.

### BACKGROUND

### 1. Technical Field

The disclosure relates to an information processing apparatus, an information processing method, and a non-transitory computer-readable storage medium.

### 2. Description of Related Art

Japanese Unexamined Patent Application Publication No. 2008-030951 (JP 2008-030951 A describes a system that predicts delivery time to each delivery destination when a delivery vehicle leaves a distribution center and delivers packages while going around delivery destinations.

### SUMMARY

The present disclosure is directed to, when a visitor intends to visit a user in a predetermined place, reducing a situation that the visitor is not able to visit the user because the user is away from the predetermined place.

A first aspect of the disclosure relates to an information processing apparatus. The information processing apparatus includes a control unit. The control unit is configured to acquire schedule information including information on schedule time that is time at which a visitor is scheduled to visit a user in a predetermined place, and, when a sign that the user leaves the predetermined place before the schedule time is detected based on an action of the user in the predetermined place, provide a notification to the user or the visitor.

A second aspect of the disclosure relates to an information processing method. The information processing method is executed by a computer. The information processing method includes acquiring schedule information including information on schedule time that is time at which a visitor is scheduled to visit a user in a predetermined place, and, when a sign that the user leaves the predetermined place before the schedule time is detected based on an action of the user in the predetermined place, providing a notification to the user or the visitor.

A third aspect of the disclosure relates to a non-transitory computer-readable storage medium storing a program. The program causes a computer to execute an information processing method. The information processing method includes acquiring schedule information including information on schedule time that is time at which a visitor is scheduled to visit a user in a predetermined place, and, when a sign that the user leaves the predetermined place before the schedule time is detected based on an action of the user in the predetermined place, providing a notification to the user or the visitor.

According to the present disclosure, when a visitor intends to visit a user in a predetermined place, a situation that the visitor is not able to visit the user because the user is away from the predetermined place is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a management system;

FIG. 2 is a block diagram schematically showing an example of the functional configuration of each of a user terminal, a camera, a management server, and a visitor terminal;

FIG. 3 is a table showing an example of the table configuration of schedule information;

FIG. 4 is a flowchart of a sending process according to a first embodiment;

FIG. 5 is a flowchart of a sending process according to a second embodiment;

FIG. 6 is a table showing an example of the table configuration of article information; and

FIG. 7 is a flowchart of a determination process.

### DETAILED DESCRIPTION OF EMBODIMENTS

An information processing apparatus according to a first aspect of the disclosure is an information processing apparatus that manages a user and a visitor who visits the user. A control unit of the information processing apparatus is configured to acquire schedule information. The schedule information is information including information on schedule time that is time at which the visitor is scheduled to visit the user in a predetermined place. The control unit of the information processing apparatus is configured to, when a sign that the user leaves the predetermined place before the schedule time is detected based on an action of the user in the predetermined place, provide a notification to the user or the visitor.

When the notification is provided to the user, the user who intends to leave the predetermined place before the schedule time is able to become aware that the visitor is coming to visit the user. Then, the user is able to wait for a visit of the visitor and prepare for a visit of the visitor in the predetermined place. This reduces the situation that the visitor is not able to visit the user because the user is away from the predetermined place.

When the notification is provided to the visitor, the visitor is able to become aware that the user intends to leave the predetermined place before the schedule time. Therefore, it is possible to prompt the visitor to visit at time earlier than the schedule time. Then, the visitor is able to visit the user before the user leaves the predetermined place. This reduces the situation that the visitor is not able to visit the user because the user is away from the predetermined place.

As described above, when the control unit of the information processing apparatus provides a notification to the user or the visitor, the visitor is able to visit the user.

Hereinafter, specific embodiments of the disclosure will be described with reference to the accompanying drawings. The dimensions, materials, and shapes of components described in the present embodiments, the arrangement of the components, and the like do not intend to limit the technical scope of the disclosure to them unless otherwise specified.

### First Embodiment

### Outline of System

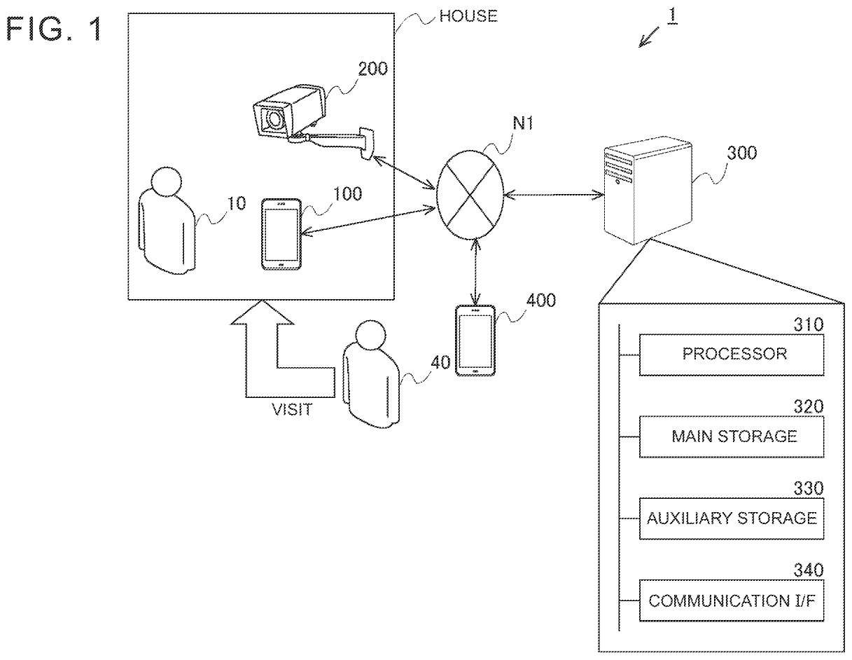

A management system 1 according to the present embodiment will be described with reference to FIG. 1. FIG. 1 is a diagram showing the schematic configuration of the management system 1. The management system 1 includes a user terminal 100, a camera 200, a management server 300, and a visitor terminal 400.

In the management system 1, the user terminal 100, the camera 200, the management server 300, and the visitor terminal 400 are connected to one another by a network N1. A wide area network (WAN) that is a worldwide public telecommunication network, such as the Internet, or a telephone communication network, such as a mobile telephone network, may be employed as the network N1.

### Visitor Terminal

The visitor terminal 400 is a terminal associated with a visitor 40. A computer, a mobile information terminal, or the like may be an example of the visitor terminal 400. The visitor 40 visits a user 10 in a house. Examples of the visitor 40 include a friend of the user 10, who visits the user 10, a delivery person who delivers an article, such as a package or a letter, to the user 10, and a bill collector who collects money from the user 10. The visitor 40 inputs schedule information including information on time at which the visitor 40 is scheduled to visit the user 10 (hereinafter, which may be referred to as schedule time) with the use of the visitor terminal 400. The visitor terminal 400 sends the schedule information to the management server 300 via the network N1.

### User Terminal

The user terminal 100 is a terminal associated with the user 10. A computer, a mobile information terminal, or the like to be used by the user 10 may be an example of the user terminal 100. The user 10 is not aware that the visitor 40 is scheduled to visit the user 10. For this reason, the user 10 may intend to leave the house before the schedule time.

### Camera

The camera 200 is a camera installed in the house. The camera 200 captures a moving image in the house. The camera 200 sends the captured moving image to the management server 300 via the network N1. A moving image to be captured by the camera 200 may contain an action being taken by the user 10 in the house.

### Management Server

The management server 300 is a server that manages the user 10 and the visitor 40. The management server 300 receives a moving image from the camera 200 via the network N1. The management server 300 receives schedule information from the visitor terminal 400 via the network N1. The management server 300 detects a sign that the user 10 leaves the house before the schedule time, based on the received moving image. When the management server 300 detects a sign that the user 10 leaves the house before the schedule time, the management server 300 provides a notification to the user 10 of a schedule of visit of the visitor 40. Specifically, the management server 300 sends information for providing a notification of a schedule of visit of the visitor 40 (hereinafter, which may be referred to as first information) to the user terminal 100 via the network N1. The notification to the user 10 of a schedule of visit of the visitor 40 in the present embodiment may be regarded as the first notification according to the disclosure.

The management server 300 includes a computer including a processor 310, a main storage 320, an auxiliary storage 330, and a communication interface (communication I/F) 340. The processor 310 is, for example, a central processing unit (CPU) or a digital signal processor (DSP). The main storage 320 is, for example, a random access memory (RAM). The auxiliary storage 330 is, for example, a read only memory (ROM). The auxiliary storage 330 is also, for example, a hard disk drive (HDD) or a disk recording medium, such as a CD-ROM, a DVD, and a Blu-ray disc. The auxiliary storage 330 may be a removable medium (portable storage medium). For example, a USB flash drive or an SD card is an example of the removable medium. The communication I/F 340 is, for example, a local area network (LAN) interface board or a wireless communication circuit for wireless communication.

In the management server 300, an operating system (OS), various programs, various information tables, and the like are stored in the auxiliary storage 330. In the management server 300, the processor 310 is capable of implementing various functions as will be described later by loading the programs stored in the auxiliary storage 330 onto the main storage 320 and then running the loaded programs. One, some, or all of the functions in the management server 300 may be implemented by a hardware circuit, such as an ASIC and an FPGA. The management server 300 does not necessarily need to be implemented by a single physical component and may be made up of a plurality of computers that cooperate with each other. The camera 200 includes a computer as well as the management server 300. The management server 300 in the present embodiment may be regarded as the information processing apparatus according to the disclosure.

### Functional Configuration

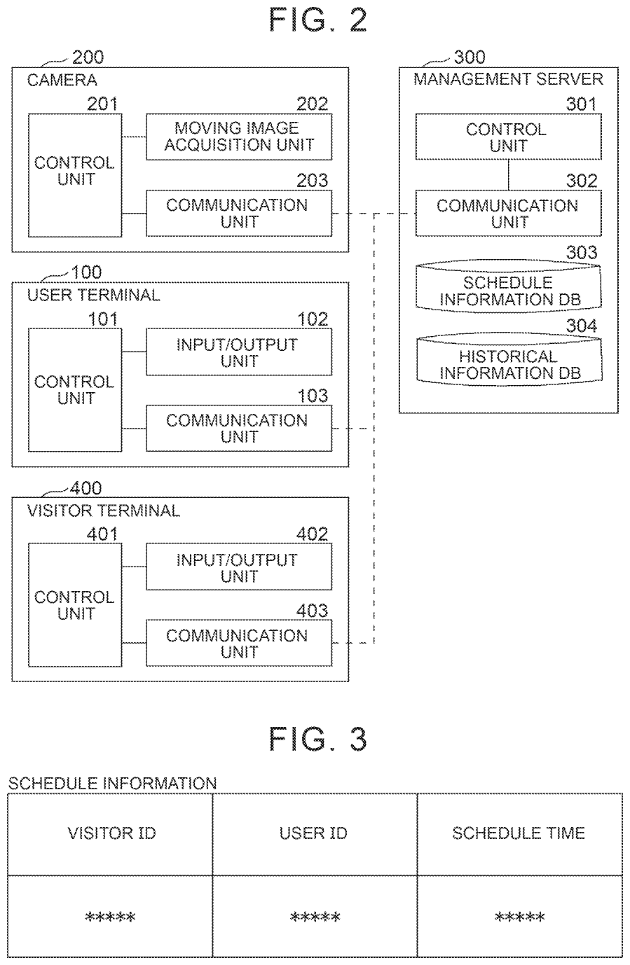

Next, the functional configuration of each of the user terminal 100, the camera 200, the management server 300, and the visitor terminal 400 that make up the management system 1 according to the present embodiment will be described with reference to FIG. 2 and FIG. 3. FIG. 2 is a block diagram schematically showing an example of the functional configuration of each of the user terminal 100, the camera 200, the management server 300, and the visitor terminal 400.

### Camera

The camera 200 includes a control unit 201, a moving image acquisition unit 202, and a communication unit 203. The control unit 201 has a function to perform arithmetic processing for controlling the camera 200. The control unit 201 may be implemented by a processor of the camera 200. The moving image acquisition unit 202 has a function to acquire a moving image captured by the camera 200.

The communication unit 203 has a function to connect the camera 200 to the network N1. The communication unit 203 may be implemented by a communication I/F of the camera 200. The control unit 201 sends a moving image acquired by the moving image acquisition unit 202 to the management server 300 via the communication unit 203.

### Visitor Terminal

The visitor terminal 400 includes a control unit 401, an input/output unit 402, and a communication unit 403. The control unit 401 has a function to perform arithmetic processing for controlling the visitor terminal 400. The control unit 401 may be implemented by a processor of the visitor terminal 400. The communication unit 403 has a function to connect the visitor terminal 400 to the network N1. The communication unit 403 may be implemented by a communication I/F of the visitor terminal 400.

The input/output unit 402 has a function for the visitor 40 to input various pieces of information to the visitor terminal 400. The input/output unit 402 has a function to display various pieces of information for the visitor 40. The input/output unit 402 may be implemented by a touch panel of the visitor terminal 400. The visitor 40 inputs via the input/output unit 402 information on schedule time to visit the user 10.

The control unit 401 generates schedule information based on information on schedule time, input via the input/output unit 402. FIG. 3 is a table showing an example of the table configuration of schedule information. As shown in FIG. 3, schedule information has a visitor ID field, a user ID field, and a schedule time field. An identifier for identifying the visitor 40 is input in the visitor ID field. An identifier for identifying the user 10 is input in the user ID field. Schedule time is input in the schedule time field. The control unit 401 sends the schedule information to the management server 300 via the communication unit 403.

### Management Server

The management server 300 includes a control unit 301, a communication unit 302, a schedule information database (schedule information DB) 303, and a historical information database (historical information DB) 304. The control unit 301 has a function to perform arithmetic processing for controlling the management server 300. The control unit 301 may be implemented by a processor 310 of the management server 300. The communication unit 302 has a function to connect the management server 300 to the network N1. The communication unit 302 may be implemented by a communication I/F 340 of the management server 300.

The schedule information DB 303 is a database for storing schedule information. The schedule information DB 303 may be implemented by the auxiliary storage 330 of the management server 300. The control unit 301 receives schedule information from the visitor terminal 400 via the communication unit 302. The control unit 301 stores the received schedule information in the schedule information DB 303.

The historical information DB 304 is a database for storing historical information. The historical information is information including information about a past action history of the user 10. The historical information DB 304 may be implemented by the auxiliary storage 330 of the management server 300.

The control unit 301 acquires a moving image captured by the camera 200 from the camera 200 via the communication unit 302. The control unit 301 performs a detection process for detecting a sign that the user 10 leaves the house before schedule time, based on an action of the user 10, contained in the acquired moving image. Specifically, the control unit 301 initially detects an action currently being taken by the user 10 based on the action of the user 10, contained in the acquired moving image. Here, a known method may be employed as a method of detecting an action currently being taken by the user 10 based on the action of the user 10, contained in the moving image. Specifically, the control unit 301 detects a sign that the user 10 leaves the house before schedule time based on the action currently being taken by the user 10 and the historical information. For example, it is assumed that the action currently being taken by the user 10 is having a meal. In addition, it is assumed that the fact that the probability that the user 10 leaves the house after having a meal is higher than the probability that the user 10 takes an action other than leaving the house after having a meal is recorded in the historical information. In this case, the control unit 301 acquires a period of time required for the user 10 to leave the house in the past after starting a meal based on the historical information. When time after a lapse of a predetermined period of time from current time is time before the schedule time, the control unit 301 detects a sign that the user 10 leaves the house before the schedule time.

When the control unit 301 detects a sign that the user 10 leaves the house before schedule time, the control unit 301 sends first information to the user terminal 100. At this time, the control unit 301 acquires the schedule time from the schedule information stored in the schedule information DB 303, generates first information including the schedule time, and sends the first information to the user terminal 100.

### User Terminal

The user terminal 100 includes a control unit 101, an input/output unit 102, and a communication unit 103. The control unit 101 has a function to perform arithmetic processing for controlling the user terminal 100. The control unit 101 may be implemented by a processor of the user terminal 100. The communication unit 103 has a function to connect the user terminal 100 to the network N1. The communication unit 103 may be implemented by a communication I/F of the user terminal 100.

The input/output unit 102 has a function for the user 10 to input various pieces of information to the user terminal 100. The input/output unit 102 has a function to display various pieces of information for the user 10. The input/output unit 102 may be implemented by a touch panel of the user terminal 100. The control unit 101 receives first information via the communication unit 103. When the control unit 101 receives the first information, the control unit 101 causes the input/output unit 102 to display a notification of a schedule of visit of the visitor 40. At this time, the control unit 101 causes the input/output unit 102 to display the schedule time contained in the first information. Thus, the user 10 is able to become aware of the schedule of visit of the visitor 40.

### Sending Process

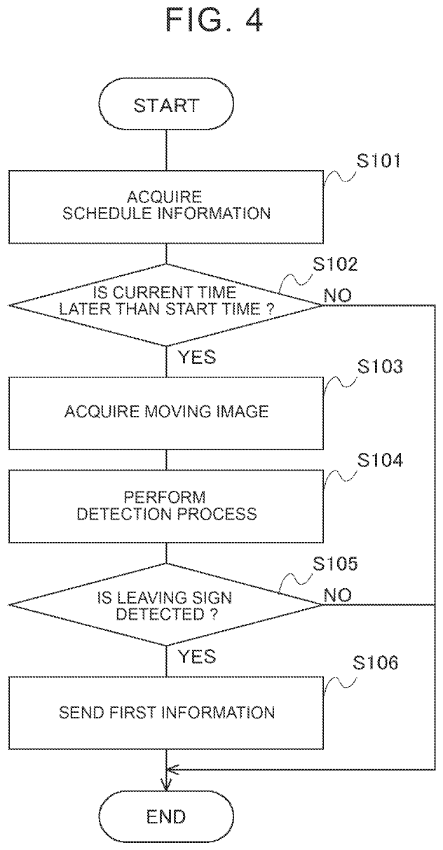

Next, a sending process that is performed by the control unit 301 in the management server 300 in the management system 1 according to the present embodiment will be described with reference to FIG. 4. FIG. 4 is a flowchart of the sending process according to the present embodiment. The sending process is a process for, when a sign that the user 10 leaves the house before schedule time is detected, sending first information to the user terminal 100. The sending process is performed when schedule information is stored in the schedule information DB 303. The sending process is repeatedly performed until schedule time.

In the sending process, initially, schedule information is acquired from the schedule information DB 303 in S101. Subsequently, it is determined in S102 whether current time is later than start time. Here, the start time is time a predetermined period of time before the schedule time. The start time is set as time to start the detection process. In other words, in S102, it is determined whether the current time is included in a period of time to perform the detection process. When the determination is negative in S102, it is not the time to start the detection process, so the sending process is once ended.

When affirmative determination is made in S102, a moving image is acquired from the camera 200 in S103. Subsequently, in S104, the detection process is performed based on the acquired moving image. In S105, it is determined whether a sign that the user 10 leaves the house before the schedule time is detected in the detection process. When the determination is negative in S105, the sending process is once ended. When the determination is affirmative in S105, the first information is sent to the user terminal 100 in S106.

As described above, when the current time is later than the start time (when the determination is affirmative in S102), the detection process is performed in S104. When the determination is affirmative in S105, the first information is sent to the user terminal 100. In this way, since the detection process is performed after start time, the control unit 301 is able to send first information to the user terminal 100 according to time at which the visitor 40 visits.

As described above, with the management system 1, first information is sent to the user terminal 100 associated with the user 10 who intends to leave the house before schedule time. Thus, the user 10 is able to become aware that the visitor 40 is coming to visit the user 10 Then, the user 10 is able to wait for a visit of the visitor 40 and prepare for a visit of the visitor 40. Thus, when the visitor 40 visits the user 10 in the house, a situation that the visitor 40 is not able to visit the user 10 because the user 10 is away from the house is reduced.

### Modification

The management server 300 does not necessarily perform the detection process based on the historical information about the user 10. A known method may be employed as a method with which the management server 300 detects a sign that the user 10 leaves the house before schedule time.

In the present embodiment, the management server 300 performs the detection process based on a moving image captured by the camera 200. However, the detection process does not necessarily need to be performed by the management server 300. The detection process may be performed by, for example, the camera 200. In this case, the management server 300 sends schedule information received from the visitor terminal 400 to the camera 200. The camera 200 detects a sign that the user 10 leaves the house based on an action currently being taken by the user 10 in the house and the schedule time contained in the schedule information. The camera 200 provides the management server 300 with a notification of detection of the sign that the user 10 leaves the house before the schedule time. When the management server 300 receives the notification from the camera 200, the management server 300 sends first information to the user terminal 100.

The management server 300 does not necessarily perform the detection process based on a moving image captured by the camera 200. The management server 300 may detect a sign that the user 10 leaves the house, based on, for example, the opening and closing of a door of an entrance of the house where the user 10 is. In this case, when a sensor provided at the door of the entrance of the house detects that the user 10 has opened the door from the inner side of the house before the schedule time, the management server 300 sends first information to the user terminal 100.

### Second Embodiment

In the present embodiment, when a sign that the user 10 leaves the house before schedule time is detected, the management server 300 provides a notification to the visitor 40 of detection of the sign that the user 10 leaves the house. The notification to the visitor 40 of detection of the sign that the user 10 leaves the house according to the present embodiment may be regarded as the second notification according to the disclosure. Hereinafter, the difference from the first embodiment will be described.

### Sending Process

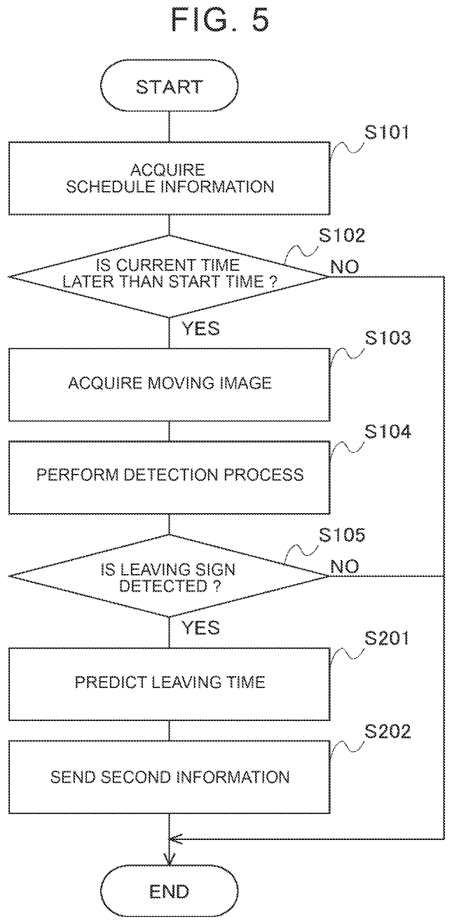

Next, a sending process that is performed by the control unit 301 in the management server 300 in the management system 1 according to the present embodiment will be described with reference to FIG. 5. FIG. 5 is a flowchart of the sending process according to the present embodiment. The sending process is a process for, when a sign that the user 10 leaves the house before schedule time is detected, sending second information to the visitor terminal 400. Here, the second information is information for providing a notification to the visitor 40 of detection of the sign that the user 10 leaves the house.

S101, S102, S103, S104, and S105 of the sending process in the present embodiment are similar to those of the first embodiment, so the description thereof is omitted. When the determination is affirmative in S105, time at which the user 10 leaves the house is predicted in S201. Specifically, the control unit 301 acquires, based on the historical information, a required period of time that is a period of time taken until the user 10 left the house when the user 10 took the same action in the past as the action currently being taken by the user 10. The control unit 301 estimates time after a lapse of the required period of time from the current time as predicted time at which the user 10 leaves the house (hereinafter, which may be referred to as leaving time).

In S202, second information is generated and sent to the visitor terminal 400. Here, the second information contains the leaving time. When the control unit 401 of the visitor terminal 400 receives the second information via the communication unit 403, the control unit 401 causes the input/output unit 402 to display a notification of detection of the sign that the user 10 leaves the house. When the control unit 401 receives the second information via the communication unit 403, the control unit 401 causes the input/output unit 402 to display the leaving time contained in the second information. Thus, the visitor 40 is able to become aware that the user 10 intends to leave the house before the schedule time, and the leaving time.

As described above, with the management system 1, second information is sent to the visitor terminal 400. Thus, the visitor 40 is able to become aware that the user 10 intends to leave the house before the schedule time. The visitor 40 is able to become aware of the time to visit the user 10 based on changed schedule time. Then, the visitor 40 is prompted to visit the user 10 before the user 10 leaves the predetermined place. Thus, when the visitor 40 visits the user 10 in the house, a situation that the visitor 40 is not able to visit the user 10 because the user 10 is away from the house is reduced.

### Modification

When the visitor terminal 400 receives the second information, the visitor terminal 400 causes the input/output unit 402 to display a notification of detection of the sign that the user 10 leaves the house. When the visitor terminal 400 receives the second information via the communication unit 403, the visitor terminal 400 causes the input/output unit 402 to display the leaving time contained in the second information. At this time, the visitor 40 changes the schedule time to time before the leaving time. The visitor 40 inputs schedule time changed by the visitor 40 via the input/output unit 402. The visitor terminal 400 sends information on the schedule time changed by the visitor 40 to the management server 300. When the management server 300 receives the information on the schedule time changed by the visitor 40, the management server 300 provides a notification to the user 10 of the schedule time changed by the visitor 40. Specifically, the management server 300 sends the information on the schedule time changed by the visitor 40 to the user terminal 100. Thus, the user 10 is able to become aware of the time at which the visitor 40 comes to visit the user 10 (the schedule time changed by the visitor 40). As a result, when the visitor 40 visits the user 10 in the house, a situation that the visitor 40 is not able to visit the user 10 because the user 10 is away from the house is reduced.

### Third Embodiment

In the present embodiment, the visitor 40 is a delivery person who delivers a package to the user 10. When a package to be delivered is a package important for the user 10 to receive, the management server 300 in the present embodiment provides a notification to the user 10 who intends to leave the house before schedule time, of a schedule of visit of the visitor 40 and information about the package. Hereinafter, only the difference from the first embodiment will be described.

### Visitor Terminal

The visitor 40 inputs information about the content of the package to be delivered to the user 10 at the time of inputting information on schedule time via the input/output unit 402. The control unit 401 generates article information including information about the package, based on information about the content of the package, input via the input/output unit 402.

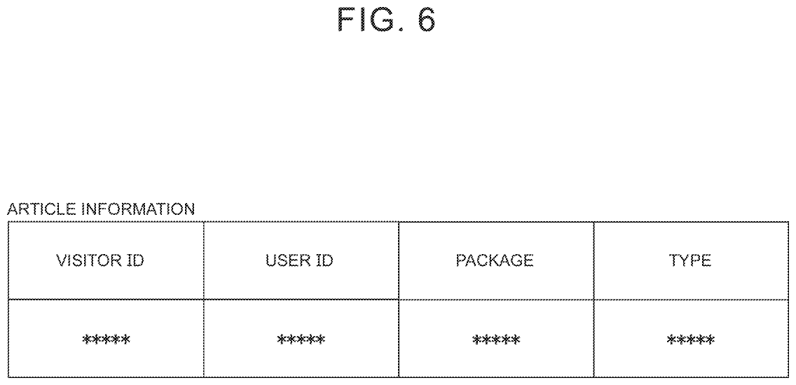

FIG. 6 is a table showing an example of the table configuration of the article information. As shown in FIG. 6, the article information has a visitor ID field, a user ID field, a package field, and a type field. Information to be input to the visitor ID field and the user ID field is similar to the information included in schedule information, so the description is omitted. Information about the content of a package is input to the package field. Information about the type of a package is input to the type field. In the present embodiment, information about the type of a package is information about whether it is important for the user 10 to receive the package. When the content of a package to be delivered to the user 10 is a freshness-important food, the control unit 301 inputs to the type field that it is important for the user 10 to receive the package. When the content of a package to be delivered to the user 10 is not a freshness-important food, the control unit 301 inputs to the type field that it is not important for the user 10 to receive the package. The control unit 401 sends the article information to the management server 300 via the communication unit 403. The article information is associated with schedule information and sent to the management server 300 together with the schedule information.

### Determination Process

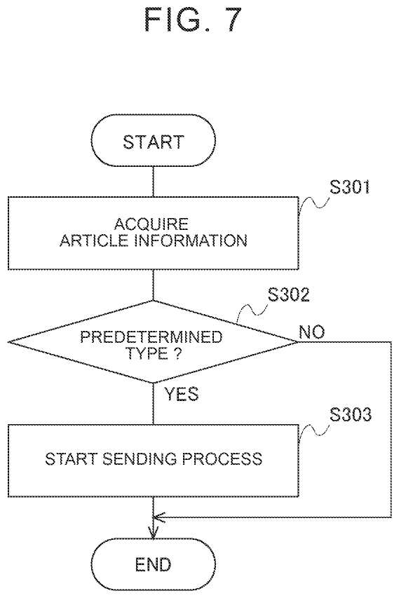

Next, a determination process that is performed by the control unit 301 in the management server 300 in the management system 1 will be described with reference to FIG. 7. FIG. 7 is a flowchart of the determination process. The determination process is a process for determining whether to start performing the sending process based on article information. Here, the determination process is started when the management server 300 receives article information.

In the determination process, initially, in S301, article information is acquired. Subsequently, in S302, it is determined whether the type of the package belongs to a predetermined type based on the acquired article information. In the present embodiment, a package that belongs to the predetermined type is a package important for the user 10 to receive a package to be delivered to the user 10. Here, the control unit 301 determines whether the package belongs to the predetermined type based on the information about whether it is important to receive a package, input in the type field of the article information.

When the determination is negative in S302, the determination process is ended. Therefore, the sending process is not started. When the determination is affirmative in S302, the sending process is started in S303. Therefore, when the package to be delivered to the user 10 by the visitor 40 is a package that belongs to the predetermined type (package important for the user 10 to receive), first information is sent to the user terminal 100 associated with the user 10 with a sign that the user 10 leaves the house before schedule time. Here, in the present embodiment, the first information is information including information about a package. Thus, the user 10 is able to become aware of the content of a package to be delivered and a package important to receive is being delivered. For this reason, a situation that the user 10 leaves the house before schedule time without being aware of the fact that a package important to receive is delivered by the visitor 40 is reduced. In other words, when the visitor 40 visits the user 10 in the house, a situation that the visitor 40 is not able to visit the user 10 because the user 10 is away from the house is reduced.

### Modification

In the present embodiment, first information is sent in the sending process. However, schedule time may be changed in the sending process, and second information may be sent. Thus, the visitor 40 is able to visit the user 10 before the user 10 leaves the house when the visitor 40 delivers a package important for the user 10 to receive. As a result, when the visitor 40 visits the user 10 in the house, a situation that the visitor 40 is not able to visit the user 10 because the user 10 is away from the house is reduced.

### Other Embodiments

The above-described embodiments are only illustrative, and the disclosure can be implemented with modifications as needed without departing from the purport of the disclosure. The processes and devices described in this disclosure may be freely implemented in combination without any technical contradiction.

A process described as the one that is performed by a single apparatus may be shared and performed by a plurality of apparatuses. Alternatively, processes described as the ones that are respectively performed by different apparatuses may be performed by a single apparatus. In a computer system, what hardware configuration (server configuration) implements functions may be flexibly changed.

The disclosure may also be implemented as follows. A computer is supplied with a computer program having the functions described in the above-described embodiments, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (a CD-ROM, a DVD, a Blue-ray disc, or the like), a read only memory (ROM), a random access memory (RAM), an EPROM, an EEPROM, a magnetic card, a flash memory, an optical card, and a medium of any type suitable for storing electronic instructions.

What is claimed is:

1. An information processing apparatus comprising a control unit configured to
acquire schedule information including information on schedule time that is time at which a visitor is scheduled to visit a user in a predetermined place, and
when a sign that the user leaves the predetermined place before the schedule time is detected based on an action of the user in the predetermined place, provide a notification to the user or the visitor.

2. The information processing apparatus according to claim 1, wherein the notification is a first notification to the user of a schedule of visit of the visitor or a second notification to the visitor of detection of the sign that the user leaves the predetermined place.

3. The information processing apparatus according to claim 2, wherein the first notification further includes the schedule time.

4. The information processing apparatus according to claim 2, wherein:
the control unit is configured to, when the sign that the user leaves the predetermined place before the schedule time is detected, predict time at which the user leaves the predetermined place; and
the second notification includes the predicted time at which the user leaves the predetermined place.

5. The information processing apparatus according to claim 4, wherein the control unit is configured to provide the user with information on schedule time changed by the visitor based on the predicted time at which the user leaves the predetermined place.

6. The information processing apparatus according to claim 2, wherein:
the visitor is a delivery person who delivers an article to the user;
the control unit is configured to acquire article information including information about the article; and
the first notification further includes the information about the article.

7. The information processing apparatus according to claim 1, wherein:
the visitor is a delivery person who delivers an article to the user;
the control unit is configured to acquire article information including information about the article; and
the control unit is configured not to provide the notification when a type of the article does not belong to a predetermined type.

8. The information processing apparatus according to claim 1, wherein detection of the sign that the user leaves the predetermined place is started a predetermined period of time before the schedule time.

9. The information processing apparatus according to claim 1, wherein:
the control unit is configured to detect the sign that the user leaves the predetermined place before the schedule time, based on an action of the user in the predetermined place; and
the action of the user is included in a moving image captured by a camera.

10. An information processing method that is executed by a computer, the information processing method comprising:
acquiring schedule information including information on schedule time that is time at which a visitor is scheduled to visit a user in a predetermined place; and
when a sign that the user leaves the predetermined place before the schedule time is detected based on an action of the user in the predetermined place, providing a notification to the user or the visitor.

11. The information processing method according to claim 10, wherein the notification is a first notification to the user of a schedule of visit of the visitor or a second notification to the visitor of detection of the sign that the user leaves the predetermined place.

12. The information processing method according to claim 11, wherein the first notification further includes the schedule time.

13. The information processing method according to claim 11, further comprising, when the sign that the user leaves the predetermined place before the schedule time is detected, predicting time at which the user leaves the predetermined place, wherein the second notification includes the predicted time at which the user leaves the predetermined place.

14. The information processing method according to claim 13, further comprising providing the user with information about schedule time changed by the visitor based on the predicted time at which the user leaves the predetermined place.

15. The information processing method according to claim 11, wherein:
the visitor is a delivery person who delivers an article to the user;
the information processing method further comprises acquiring article information including information about the article; and
the first notification further includes the information about the article.

16. The information processing method according to claim 10, wherein:
the visitor is a delivery person who delivers an article to the user; and
the information processing method further comprises:
acquiring article information including information about the article; and
not providing the notification when a type of the article does not belong to a predetermined type.

17. The information processing method according to claim 10, wherein detection of the sign that the user leaves the predetermined place is started a predetermined period of time before the schedule time.

18. The information processing method according to claim 10, further comprising detecting, by the computer, the sign that the user leaves the predetermined place before the schedule time, based on an action of the user in the predetermined place, wherein the action of the user being included in a moving image captured by a camera.

19. A non-transitory computer-readable storage medium storing a program causing a computer to execute an information processing method, the information processing method comprising:
acquiring schedule information including information on schedule time that is time at which a visitor is scheduled to visit a user in a predetermined place; and
when a sign that the user leaves the predetermined place before the schedule time is detected based on an action of the user in the predetermined place, providing a notification to the user or the visitor.

20. The non-transitory computer-readable storage medium according to claim 19, wherein the notification is a first notification to the user of a schedule of visit of the visitor or a second notification to the visitor of detection of the sign that the user leaves the predetermined place.
